(19) United States
(12) Patent Application Publication
(10) Pub. No.: US 2026/0213686 A1
(43) Pub. Date: Jul. 23, 2026

(54) MAGNETICALLY GEARED SYSTEMS AND METHODS

(71) Applicant: Magnomatics Limited, Sheffield, South Yorkshire (GB)

(72) Inventor: Stuart Calverley, Sheffield, South Yorkshire (GB)

(21) Appl. No.: 19/143,213

(22) PCT Filed: Dec. 15, 2023
(86) PCT No.: PCT/GB2023/053262

§ 371 Date: Jun. 25, 2025

(30) Foreign Application Priority Data
Dec. 28, 2022 (GB) 2219790.9

(51) Int. Cl. H02P 21/22; H02K 11/21; H02P 21/20; H02P 25/03

(52) U.S. Cl. CPC H02P 21/22; H02K 11/21; H02P 21/20; H02P 25/03; H02P 2207/03

(57) ABSTRACT

Disclosed herein is a system comprising: a stator comprising a plurality of windings configured to generate a rotating magnetic field; a first rotor comprising a plurality of permanent magnets having an associated second magnetic field; a second rotor through which the rotating magnetic field and the second magnetic field are coupled, whereby rotation of the first rotor is magnetically coupled to rotation of the second rotor; a first rotational sensor associated with the first rotor; a second rotational sensor associated with the second rotor; and a controller configured to control a current supplied to the windings based on a signal from the first sensor and a signal from the second sensor; wherein one of the first rotor and the second rotor is a drive rotor configured for attachment to an external load, and the other of the first rotor and the second rotor is a passive rotor.

### RELATED APPLICATION

The present application is a national stage application under 35 U.S.C. § 371 of International Application No. PCT/GB2023/053262, filed Dec. 15, 2023, which claims priority to Great Britain Patent Application No. 2219790.9 filed Dec. 28, 2022. The above-referenced applications are hereby incorporated by reference into the present application in their entirety.

### FIELD

The present disclosure relates to magnetically geared systems, and to corresponding methods.

### BACKGROUND

A magnetically geared system 100 operable as a motor is shown in FIGS. 1A and 1B. The magnetically geared system 100 includes an outer stator 102, a first (inner) rotor 104, and a second (intermediate) rotor 106 positioned radially between the stator 102 and the first rotor 104. The stator 102 comprises a plurality of circumferentially arranged conductive windings 108 and a first plurality of permanent magnets 120, the first rotor 104 comprises a second plurality of circumferentially arranged permanent magnets 110, and the second rotor 106 comprises plurality of circumferentially arranged unmagnetised magnetisable (typically ferromagnetic, e.g. steel) pole pieces 112. One of the first rotor 104 and the second rotor 106 can be connected to an external load (for example, the wheels of a vehicle). The other of the first rotor and the second rotor is passive, in that it is not connected to a load. In the depicted example, the second rotor is configured for connection to a load, and the first rotor is passive. That is, there is a shaft 118 coupled to the second rotor 106. There is no shaft coupled to the first rotor 104.

The first plurality of permanent magnets 120 produce a first magnetic field, and the second plurality of permanent magnets 110 produce a second magnetic field. The pole pieces 112 modulate the interaction between the first and second magnetic fields, coupling the magnetic fields to produce a geared interaction between the first rotor 104 and the second rotor 106. In the example shown, the first rotor 104 comprises 3 magnetic pole pairs, and the second rotor 106 comprises 21 pole pieces. Accordingly, the second rotor will rotate at a geared (lower) speed than the first rotor, at a gear ratio of 1/7.

Additionally, by supplying the windings 108 of the stator with a three-phase, 120 degree displaced current, a rotating magnetic field is set up in the system 100. This rotating magnetic field may have the same number of pole pairs as the first magnetic field generated by the first permanent magnets 110.

Accordingly, the rotating magnetic field applies an electromagnetic torque to the first rotor, thereby driving rotation of the first rotor 104. Furthermore, because of the magnetic coupling as described above, this in turn will drive rotation of the second rotor 106, at a geared lower speed than the first rotor 104.

In FIGS. 1A and 1B, the drive shaft 118 is attached to the second rotor 106. Accordingly, the rotating magnetic field drives rotation of the drive shaft 118 at the geared, lower speed. Therefore, the example of FIGS. 1A and 1B is particularly well suited to high-torque applications (thanks to the 1/7 gear ratio), in which large loads are to be connected to the drive shaft. However, as the reader will understand, in some examples the drive shaft 118 may be attached to the first rotor.

Bearings B1 enable the first rotor 104 to rotate relative to the drive shaft 118. Similarly, bearings B2 enable the drive shaft and the second rotor 106 to rotate relative to the stator 102.

A problem in systems such as that shown in FIGS. 1A and 1B, is that under high load torque, the rotating magnetic field may become decoupled from the rotor driving the drive shaft 118, at which point the electrical drive input into the windings 108 of the system 100 will not drive rotation of the drive shaft 118, and instead a vibration will be observed in the system 100.

### SUMMARY

The present disclosure has been developed to overcome the above problem.

In a first aspect, there is provided a system comprising:
a stator comprising a plurality of windings configured to generate a rotating magnetic field;
a first rotor comprising a plurality of permanent magnets having an associated second magnetic field;
a second rotor through which the rotating magnetic field and the second magnetic field are coupled, whereby rotation of the first rotor is magnetically coupled to rotation of the second rotor;
a first rotational sensor associated with the first rotor;
a second rotational sensor associated with the second rotor; and
a controller configured to control a current supplied to the windings based on a signal from the first sensor and a signal from the second sensor;
wherein one of the first rotor and the second rotor is a drive rotor configured for attachment to an external load, and the other of the first rotor and the second rotor is a passive rotor.

In particular, the fact that the rotating magnetic field couples with the second magnetic field through the second rotor, in turn causes a magnetic coupling between the first and second rotors, which in turn gives rise to a geared interaction between the first and second rotors.

The inventors have found that by determining rotational dynamics of both rotors, in spite one of those rotors being a passive rotor, it is possible to accurately determine when decoupling of the rotating magnetic field from the drive rotor is likely to occur, and therefore effectively prevent this decoupling by controlling the current supplied to the windings. In particular, the inventors have found that the relative rotational dynamics of the two rotors is indicative of a decoupling risk between the rotating magnetic field and the drive rotor. The technical principle of this is described in more detail in the specific description that follows. In short, the first aspect makes use of the passive rotor dynamics to improve operation, even though the passive rotor is not connected to an external load.

Herein, the passive rotor may be defined as not being connected to a load external to the system. It may be driven only by the rotating magnetic field. The drive rotor may be connected to a drive shaft, for driving an external load.

Optional features will now be described.

The second rotor may be located between the first rotor and the stator. The second rotor may be the drive rotor. The first rotor may be the passive rotor.

The system may be a motor. The stator may further comprise a plurality of permanent magnets having an associated first magnetic field. The second rotor may be arranged to couple the magnetic fields of the stator (that is, the first magnetic field and the rotating magnetic field) with the second magnetic field.

The second rotor may comprise a plurality of pole pieces through which the magnetic field(s) of the stator couple with the second magnetic field. Each pole piece may comprise an unmagnetised magnetisable material (for example an unmagnetised ferromagnetic material, such as unmagnetised steel).

Each rotational sensor may comprise a rotary encoder or a rotary resolver. In some examples, at least one of the rotor positions may be calculated.

Each sensor may output a signal indicative of an angular position of the respective rotor. The controller may be configured to:
determine a load angle of the system based on the angular position of the first rotor and the angular position of the second rotor; and
adjust the current supplied to the windings based on the determined load angle.

Herein an angular position of a rotor may mean a rotational angle of the rotor, e.g. relative to a fixed point on (or orientation of) the stator. The fixed point or orientation may be any arbitrary fixed point on (or orientation of) the stator. Both rotor angular positions may be measured relative to the same fixed point or fixed orientation on the stator.

The load angle may be a measure of the angular displacement (e.g. phase difference) between the second magnetic field and a magnetic field induced in the pole pieces of the second rotor. As the skilled person will understand, for a given system (having a given number of permanent magnets and a given number of pole pieces), load angle may be governed by the angular position of the first rotor and the angular position of the second rotor. Herein, load angle, θₑ, may be defined as follows:

$${θ}_{e} = {θ}_{R 2} {N}_{R 2} - {θ}_{R 1} {N}_{R 1} ,$$

where θ_{R1} is the rotational angle of the first rotor, N_{R1} is the number of pole pairs (which may be equal to the number of permanent magnets) on the first rotor, θ_{R2} is the rotational angle of the second rotor, and N_{R2} is the number of pole pieces on the second rotor. For a given system, N_{R1} and N_{R2} are known, and are fixed.

When the load angle approaches 90°, there is a risk of pole slip-a phenomenon by which the magnetic poles of constituent magnetic fields in the system ‘slip’ past one another, thereby preventing the electromagnetic torque of the rotating magnetic field from being transferred to the first rotor, and by extension to an external load. Because the relative angular positions (i.e. relative rotational angles) of the drive and passive rotors are directly related to the load angle in the system, the load angle may be determined based on the relative angular positions of the drive and passive rotors.

Adjusting the current supplied to the windings may comprise adjusting a magnitude of the current supplied to the windings. For example, the controller may be configured to modify (e.g. reduce) the magnitude of the current supplied to the windings when the load angle increases above a predetermined threshold. For example, the controller may be configured to modify (e.g. reduce) the magnitude of the current supplied to the windings in proportion to an amount by which the load angle exceeds the predetermined threshold.

Alternatively, or additionally, the controller may be configured to modify (e.g. reduce) the magnitude of the current supplied to the windings in proportion to a rate at which the load angle increases above the predetermined threshold. As the reader will understand, this approach may enable a predictive control.

In another example, the controller may be configured to modify (e.g. reduce) the magnitude of the current supplied to the windings when it is determined that a rate at which the load angle is increasing is expected to cause the load angle to increase above the predetermined threshold.

The predetermined threshold may be at least 60 degrees, for example at least 70 degrees, for example at least 80 degrees. The predetermined threshold may be at most 90 degrees, for example at most 85 degrees.

Each sensor may alternatively output a signal indicative of a rotational speed of the respective rotor, or the angular difference between successive position signals with a known time difference may be used to calculate speed. The controller may be configured to:
determine a gear ratio (e.g. instantaneous gear ratio) between the first and second rotors based on the rotational speeds (e.g. current rotational speeds) of the rotors; and
adjust the current supplied to the windings based on the determined gear ratio.

The gear ratio may be determined as a ratio of the rotational speed of the first rotor to the rotational speed of the second rotor.

The adjustment may be an adjustment of a magnitude of the current supplied to the windings.

The controller may be configured to:
determine an actual gear ratio between the first and second rotors based on the rotational speeds of the rotors;
detect when the actual gear ratio differs from a target gear ratio by a predetermined amount; and
modulate the current supplied to the windings when the actual gear ratio differs from the target gear ratio by the predetermined amount. Modulating the current supplied to the windings may comprise changing a magnitude of the current supplied to the windings, for example reducing the magnitude of the current supplied to the windings.

The actual gear ratio may be defined as follows:

$$actual gear ratio = \frac{first rotor rotational speed}{second rotor rotational speed}$$

The target gear ratio may be defined as follows:

$$target gear ratio = \frac{number of pole pieces on the second rotor}{number of permanent magnets on the first rotor}$$

In a second aspect there is provided a method of operating a system (for example a system according to the first aspect), the system comprising:
a stator comprising a plurality of windings configured to generate a rotating magnetic field;
a first rotor comprising a plurality of permanent magnets having an associated second magnetic field; and
a second rotor through which the rotating magnetic field and the second magnetic field are coupled, whereby rotation of the first rotor is magnetically coupled to rotation of the second rotor;
wherein one of the first rotor and the second rotor is a drive rotor configured for attachment to an external load, and the other of the first rotor and the second rotor is a passive rotor,
the method comprising:
determining one of a angular position and a rotational speed of the first rotor;
determining one of a angular position and a rotational speed of the second rotor; and
controlling a current supplied to the windings based on the determined angular position or rotational speed of the first rotor, and based on the determined angular position or rotational speed of the second rotor.

Optional features are described below. As the reader will understand, optional features of the first aspect are also applicable to the second aspect.

Determining the second rotor position may comprise detecting the second rotor position. Determining the first rotor position may comprise detecting or calculating the first rotor position. In an exemplary example, determining the first rotor position comprises detecting the first rotor position.

The angular position of the first rotor and the angular position of the second rotor may be determined. The method may further comprise:
determining a load angle of the system based on the angular position of the first rotor and the angular position of the second rotor; and
adjusting the current supplied to the windings based on the determined load angle.

The magnitude of the current supplied to the windings may be reduced when the load angle increases above a predetermined threshold. For example, the magnitude of the current supplied to the windings may be reduced in proportion to an amount by which the load angle exceeds the predetermined threshold. For example, the magnitude of the current in the windings may be reduced towards zero as the amount by which the load angle exceeds the predetermined threshold increases. For example, the magnitude of the current in the windings may be gradually reduced such that when the load angle reaches a second predetermined threshold which is larger than the first predetermined threshold, the current in the windings is zero. Alternatively, or additionally, the magnitude of the current supplied to the windings may be reduced in proportion to a rate at which the load angle increases above the predetermined threshold.

The rotational speed of the first rotor and the rotational speed of the second rotor may be determined. The method may further comprise:
determining a gear ratio between the first rotor and the second rotor based on the rotational speeds of the rotors; and
modifying a magnitude of the current supplied to the windings based on the determined gear ratio.

The method may comprise:
determining an actual gear ratio between the first and second rotors based on the rotational speeds of the rotors;
detecting when the actual gear ratio differs from a target gear ratio by a predetermined amount; and
reducing the magnitude of the current supplied to the windings when the actual gear ratio differs from the target gear ratio by the predetermined amount.

In a third aspect there is provided a system comprising:
a stator comprising a plurality of windings configured to generate a rotating magnetic field;
a first rotor comprising a plurality of permanent magnets having an associated second magnetic field;
a second rotor through which the rotating magnetic field and the second magnetic field are coupled, whereby rotation of the first rotor is magnetically coupled to rotation of the second rotor;
a rotational sensor associated with the second rotor and configured to detect a rotational position of the second rotor; and
a controller configured to:
calculate an electromagnetic torque in the system, based on a magnitude of a current supplied to the windings (for example according to equation 14 of the present disclosure, or according to a lookup table);
calculate an estimated load angle of the system based on the electromagnetic torque and a known maximum torque capacity of the system (for example according to equation 12 of the present disclosure);
calculate a theoretical first rotor position based on the detected second rotor position and a known gear ratio of the system (for example according to equation 15 of the present disclosure);
control a phase of the current supplied to the windings such that the rotating magnetic field is offset from an electrical angle associated with the theoretical first rotor position by the estimated load angle (for example according to equation 16 of the present disclosure).

One of the first rotor and the second rotor may be a drive rotor configured for attachment to an external load, and the other of the first rotor and the second rotor may be a passive rotor. The second rotor may be located between the first rotor and the stator. The second rotor may be the drive rotor. The first rotor may be the passive rotor.

The system may be a motor. The stator may further comprise a plurality of permanent magnets having an associated first magnetic field. The second rotor may be arranged to couple the magnetic fields of the stator (that is, the first magnetic field and the rotating magnetic field) with the second magnetic field.

The second rotor may comprise a plurality of pole pieces through which the magnetic field(s) of the stator couple with the second magnetic field. Each pole piece may comprise an unmagnetised magnetisable material (for example an unmagnetised ferromagnetic material, such as unmagnetised steel).

The rotational sensor may comprise a rotary encoder or a rotary resolver.

In a fourth aspect there is provided a method of operating a system (for example a system according to the third aspect), the system, comprising:
a stator comprising a plurality of windings configured to generate a rotating magnetic field;
a first rotor comprising a plurality of permanent magnets having an associated second magnetic field;
a second rotor through which the rotating magnetic field and the second magnetic field are coupled, whereby rotation of the first rotor is magnetically coupled to rotation of the second rotor;
a rotational sensor associated with the second rotor and configured to detect a rotational position of the second rotor;
and the method comprising:
calculating an electromagnetic torque in the system, based on a magnitude of a current supplied to the windings (for example according to equation 14 of the present disclosure, or according to a lookup table);
calculating an estimated load angle of the system based on the electromagnetic torque and a known maximum torque capacity of the system (for example according to equation 12 of the present disclosure);
calculating a theoretical first rotor position based on the detected second rotor position and a known gear ratio of the system (for example according to equation 15 of the present disclosure);
controlling a phase of the current supplied to the windings such that the rotating magnetic field is offset from an electrical angle associated with the theoretical first rotor position by the estimated load angle (for example according to equation 16 of the present disclosure).

Finally, disclosed herein is a computer readable medium (such as a non-transitory computer readable medium) having instructions stored thereon which, when executed by a processor, perform any one of the methods described or claimed herein.

### BRIEF DESCRIPTION OF THE DRAWINGS

The present disclosure will now be described in further detail, with reference to the accompanying drawings, in which:

FIG. 1A shows a cross-sectional view of a known magnetically geared system;

FIG. 1B shows an axial view of the magnetically geared system of FIG. 1A;

FIG. 2 shows a cross-sectional view of a magnetically geared system according to the present disclosure, which is a modification of the magnetically geared system of FIG. 1A;

FIG. 3 shows a controller for controlling the magnetically geared system of FIG. 2;

FIG. 4 shows a first method of controlling a system according to FIG. 2, according to the present disclosure;

FIG. 5 shows a second method of controlling a system according to FIG. 2, according to the present disclosure;

FIG. 6 shows a third method of controlling a system according to FIG. 2, according to the present disclosure;

FIG. 7 shows a fourth method of controlling a system according to FIG. 2, according to the present disclosure;

FIG. 8 shows a fifth method of controlling a system according to FIG. 1 or FIG. 2, according to the present disclosure;

FIG. 9 shows an illustration of load angles in a system according to the present disclosure; and

FIG. 10 shows a schematic and simplified representation of a computer apparatus which can be used to perform methods described herein.

Like reference numerals are used for like components throughout the drawings.

### DETAILED DESCRIPTION

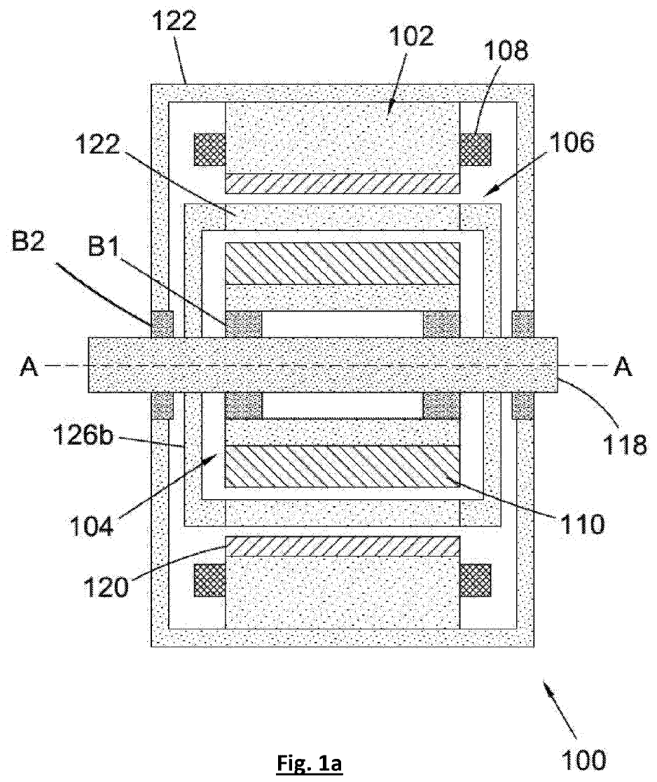

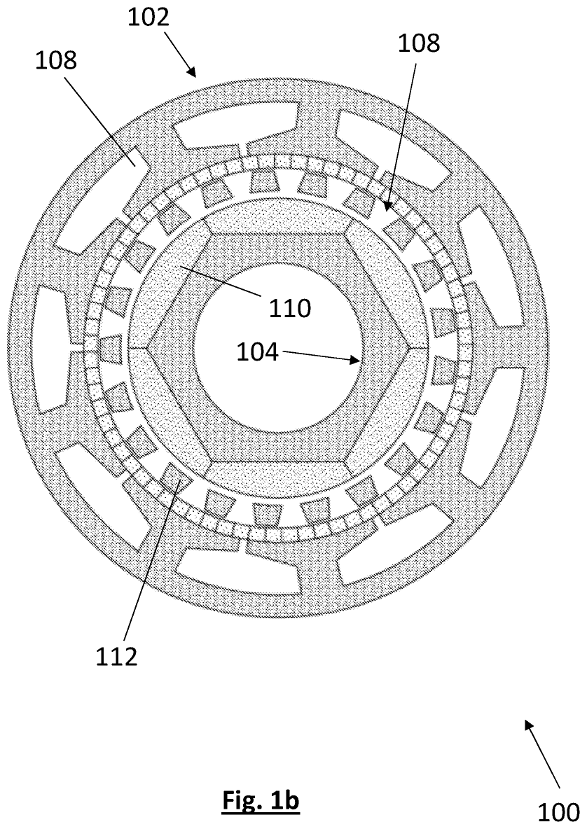

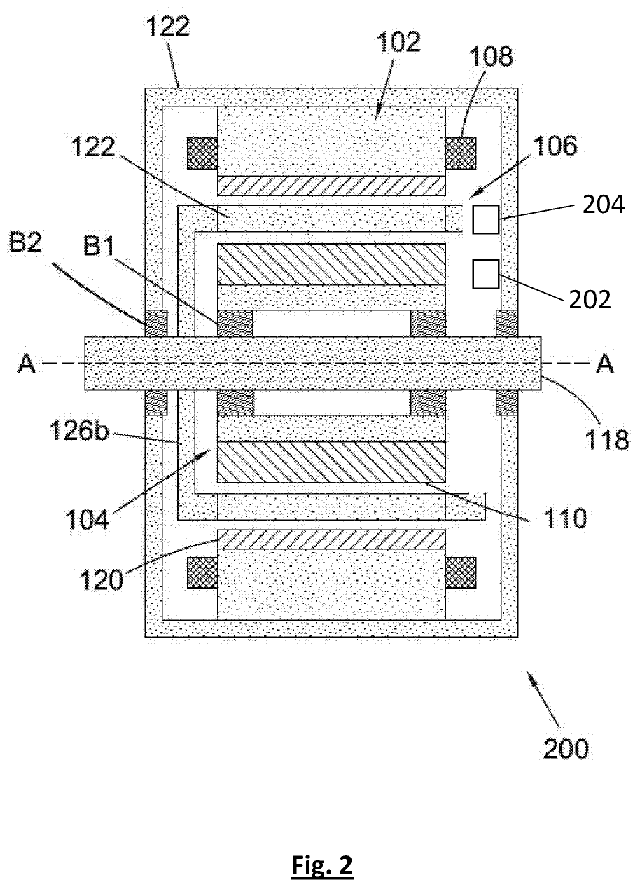

FIG. 2 shows a magnetically geared system 200 according to an example of the present disclosure. The magnetically geared system 200 includes the same components as the magnetically geared system 100 shown in FIGS. 1A and 1B. However, the magnetically geared system 200 further includes a first rotary encoder 202 to measure the rotational dynamics of the first rotor 104, and a second rotary encoder 204 to measure the rotational dynamics of the second rotor 106.

The basic principle of operation of the magnetically geared system 200 will first be described.

The frequency of the current(s) supplied to the windings 108 is controlled such that a rotating magnetic field created by the stator current(s) rotates at the same speed as the second field generated by the second plurality of permanent magnets 110, i.e. as the first rotor 104 rotates. Furthermore, the phase of the current(s) is typically maintained such that the rotating magnetic field created by the stator windings 108 remains synchronous with the second magnetic field associated with the first rotor 104 (i.e. continues to rotate at the same speed as the first rotor), at a constant angular difference (phase angle) of 90°. By maintaining a phase angle which is 90 degrees, the maximum torque per ampere is achieved by the current supplied to the windings.

The second magnetic field of the second plurality of permanent magnets 110 is modulated by the pole pieces 112, thereby generating a first consequential magnetic field associated with the second rotor. The first consequent magnetic field has 18 pole pairs (21 pole pairs from the pole pieces 112, less 3 pole pairs from the second permanent magnets 110). As the skilled person will understand, the pole pieces 112 (each of which comprises an unmagnetised magnetisable material, such as unmagnetised steel) will only act as magnetic poles due to being externally magnetized. The first consequential magnetic field interacts with the first plurality of permanent magnets 120 as they now have the same number of pole pairs. The first consequent, 18 pole pair magnetic field has an angular position (θ_{C1}) relative to the stationary stator 102 given by equation 1:

$${θ}_{C 1} = \frac{( {θ}_{R 2} {N}_{R 2} - {θ}_{R 1} {N}_{R 1} )}{{N}_{stator}} \qquad ( 1 )$$

where θ_{R1} is the rotational angle of the first rotor 104, N_{R1} is the number of pole pairs (which may be equal to the number of second permanent magnets 110, where each pole pair is provided by a single permanent magnet) on the first rotor 104, θ_{R2} is the rotational angle of the second rotor 106, N_{R2} is the number of pole pieces 112 on the second rotor 106, and Nₛₜₐₜₒᵣ is the number of magnet pole pairs on the stator 102 (which may be equal to the number of first permanent magnets 120 on the stator 102, where each pole pair is provided by a single permanent magnet). θ_{C1} may sometimes be defined herein as a mechanical angle, because it is in mechanical degrees—i.e. maps by a 1:1 ratio to angles on the stationary stator component. This, a time derivative of θ_{C1} would give a rotational speed relative to the reference frame of the stator.

By considering the relationship between angular positions, the angular velocity of the first consequent magnetic field relative to the stator 102 (ω_{C1}) can be determined from the time derivates of the rotor positions, given by equation 2:

$${ω}_{C 1} = \frac{( {ω}_{R 2} {N}_{R 2} - {ω}_{R 1} {N}_{R 1} )}{{N}_{stator}} \qquad ( 2 )$$

where ω_{R2} is the angular velocity of the second rotor, i.e. the time derivative of the second rotor position; and ω_{R1} is the angular velocity of the first rotor, i.e. the time derivative of the first rotor position.

In order for the system to stay synchronous, the first consequential field must be stationary relative to the first plurality of permanent magnets 120. Therefore, ω_{C1} must be zero. And by extension, the numerator of the above equation must be zero, given by equation 3:

$${ω}_{R 2} {N}_{R 2} - {ω}_{R 1} {N}_{R 1} = 0 \qquad ( 3 )$$

and hence the second rotor speed is adjusted such that

$${ω}_{R 2} = {ω}_{R 1} \frac{{N}_{R 1}}{{N}_{R 2}} \qquad ( 4 )$$

$$or$$

$${ω}_{R 2} = {ω}_{R 1} \frac{1}{7} \qquad ( 5 )$$

in the example system 200 of FIG. 2. Therefore, we see that an effective gear ratio of the system is governed by the number of pole pieces 112 and the number of second permanent magnets 110 on the first rotor 104.

The relative electrical angular displacement (θₑ) between the rotors, also referred to herein as the load angle of the system, can be written as equation 6:

$${θ}_{e} = {θ}_{R 2} {N}_{R 2} - {θ}_{R 1} {N}_{R 1} \qquad ( 6 )$$

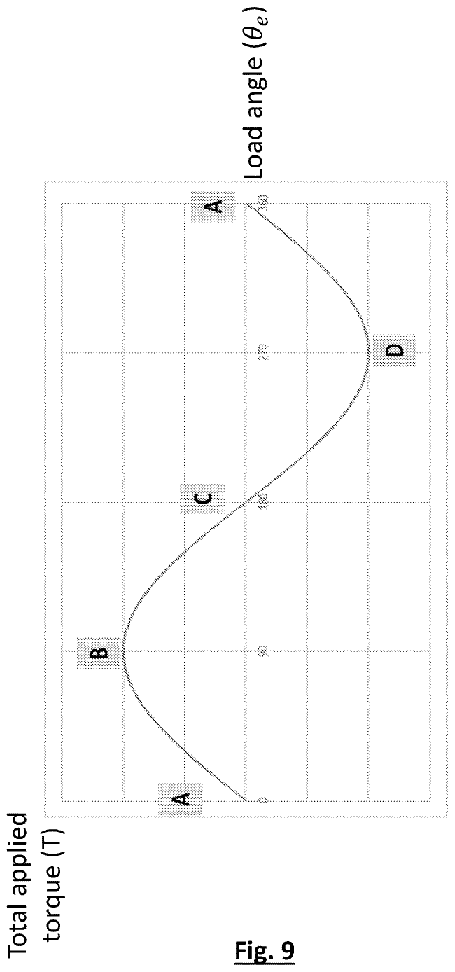

The load angle (θₑ) is zero when the system is at rest (with no torque applied). This corresponds to position A in FIG. 9. In this state, the poles in the system are perfectly aligned. This is a stable state.

As load is applied to the system, the load angle (θₑ) increases, until the total applied torque reaches a maximum for the system 200, corresponding to point B in FIG. 9, at which point the load angle is 90°. This represents the maximum static torque the magnetic system can react. If the torque is increased above the maximum torque of the system, the load angle increases yet further and the load capability of the magnetic gear reduces, thereby causing the load angle to increase above 90°. At point C, the load angle has increased to 180°, the total torque being transmitted is zero, and the system is highly unstable as the poles in the system are perfectly opposing one another. Moving to point D (load angle of) 270°, the torque is negative which will further enhance this pole slipping effect. Accordingly, the load angle will return to) 0° (360°, at which point the same pole slipping phenomenon will continue until the total applied torque is reduced to below the maximum torque of the system. Once the total applied torque is reduced to below the maximum torque of the system, the pole slipping will stop when the system next approaches or reaches a load angle of 90° (point B). In short, to maximise the torque capacity of a system, it is desirable to maintain the load angle at close to, but less than, 90° (point B). At the same time, to avoid pole slip, it is necessary to restrict the load angle from increasing above 90°.

The torque of the gear can be controlled by the torque applied to the first rotor 104 from the rotating field from the windings. Under steady state load conditions the load angle will remain constant and pole slip will be avoided. For the case of the motor a sudden increase in load torque (e.g. a sudden increase of torque or load at the shaft 118) will cause a sudden deceleration of the output shaft 118 and accordingly the second rotor 106. The inertia of the first rotor 104 will prevent the speed of this rotor from decelerating as quickly, and accordingly the load angle will increase, thereby increasing a risk of pole slip. In this case the second rotor 104 must also be decelerated by reducing the torque applied to the second rotor 104 via the current in the stator windings, if pole slip is to be avoided.

Approaches according to the present disclosure for detecting imminent pole slip, thereby enabling a correction to prevent pole slip as described above, will now be described.

The total applied torque (T) on the output rotor 118 in a magnetically geared system 200 such as that shown in FIG. 2, is equal to the applied electromagnetic torque on the first rotor 104 multiplied by the gear ratio (Tint) plus the external load torque (Text). The external torque (Text) may in some situations be negative. Total applied torque is given by equation 7.

If the magnitude of the current supplied to the windings 108 is increased (thereby increasing the electromagnetic torque Tint) the total applied torque T will in turn increase. Furthermore, in the example of an electrically driven vehicle, if the wheels being driven by the drive shaft 118 become stuck, the total applied torque T will spike due to the increased load torque Text on the drive shaft 118.

$$T = {T}_{int} + {T}_{ext} \qquad ( 7 )$$

Pole slip is a phenomenon by which the rotating magnetic field in the magnetically geared system 200 becomes decoupled from rotation of the drive shaft 118, whereby the magnetic poles of the rotating magnetic field generated by the current in the windings 108 ‘slip’ past the magnetic poles associated with the second plurality of permanent magnets 110. This in turn causes a loss of drive, and a vibration on the drive shaft 118 as the poles of the rotating magnetic field and the second magnetic field continually un-align and re-align. As shown in equation 8, increasing the total applied torque on the magnetically geared system 200 increases a load angle (θₑ) of the system (defined herein as the angular displacement between the rotating magnetic field and the second magnetic field), up to a maximum load angle of 90 degrees, at which point a maximum torque (Tmax) of the system is reached.

$$T = {T}_{max} \cdot sin ( {θ}_{e} ) \qquad ( 8 )$$

If the total applied torque T exceed the system's maximum torque Tmax, the maximum torque capacity of the system is exceeded at all load angles, at which point equation 8 cannot be satisfied for any load angle, such that a pole slip condition occurs, whereby the rotating magnetic field rotates relative to the second magnetic field, i.e. without causing rotation of the first rotor 104.

At the same time that the pole slip condition occurs, causing decoupling of the rotating magnetic field from the second magnetic field, the rotation of the first rotor 104 will similarly become decoupled from rotation of the second rotor 106. Additionally, the load angle of the system is intrinsically related to the angular positions of the first and second rotors, as shown in equation 6.

Accordingly, even though only the second rotor 106 is connected to the external load (via the drive shaft 118), both rotor positions can be used to infer a load angle between the rotating magnetic field and the first rotor, such that a risk of pole slip (i.e. when the load angle approaches) 90° can be identified. Accordingly, first rotary encoder 202 and second rotary encoder 204 can be used to detect and prevent pole slip conditions from occurring.

By detecting load angle using rotor dynamics of the first rotor 104 and the second rotor 106, using rotary encoders 202, 204 as described above, it is then possible to control current supplied to the windings 108 so as to prevent pole slip from occurring. In particular, given that the electromagnetic torque Tint is proportional to an amplitude of the current supplied to the windings 108, a controller can be used to reduce the current supplied to the windings 108 when a pole slip condition—or a risk of a pole slip condition—is detected.

As the reader will understand, the load angle may be positive or negative (depending on the rotation direction of the system 200). Herein, the load angle may therefore be a magnitude of load angle (i.e. agnostic of rotation direction).

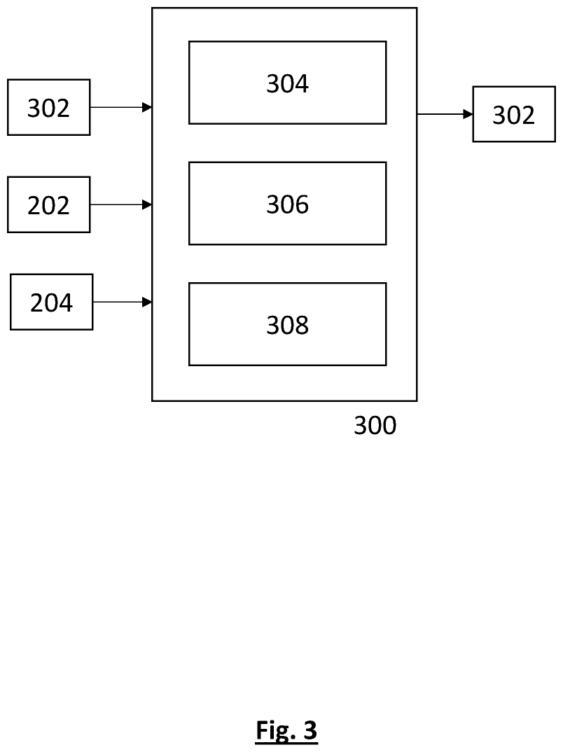

FIG. 3 shows a controller 300 for controlling the system 200 of FIG. 2 so as to prevent pole slip. As shown, the controller receives a signal from the first rotational encoder 202, receives a signal from the second rotational encoder 204, and receives a signal indicative of a current being supplied to the windings 108 from a drive unit 302. Controller includes a transitory storage unit (RAM) 304 for storing the signals received from the first rotational encoder 202, the second rotational encoder 204, and the drive unit 302. The controller also includes a processor 306, and a storage unit 308. The storage unit 308 has instructions stored thereon for causing the processor 306 to process the signals stored in the transitory storage unit 304, and in turn generate a control signal for adjusting the current supplied to the windings 108. As shown, the control signal is output to the drive unit 302.

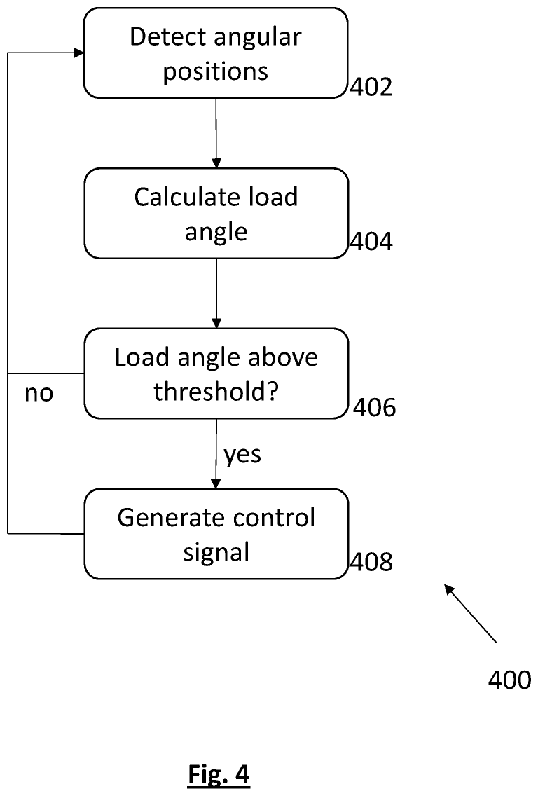

FIGS. 4 to 8 show a number of methods of controlling the magnetically geared system 200 according to the determined rotational dynamics of the first rotor 104 and the second rotor 106. The instructions stored on the storage unit 308 may thus be configured to implement a method as outlined in any of FIGS. 4 to 8.

FIG. 4 shows a first method 400 of controlling the current supplied to the windings 108 in the system 200 of FIG. 2, according to the present disclosure. According to the first method, a threshold load angle is applied, above which an adjustment (reduction) of the current to the windings is applied.

At step 402, an angular position of the first rotor 104 is determined based on a signal from the first rotary encoder 202; and an angular position of the second rotor 106 is determined based on a signal from the second rotary encoder 204.

At step 404, a load angle (θₑ) of the system is calculated, using equation 6 above.

At step 406, the calculated load angle θₑ (actual load angle) is compared with a threshold load angle (θₜₕ). The threshold load angle may be 90°. In some examples, the threshold angle may be less than 90°, for example 80°. Using a threshold angle of less than 90° help to provide a small buffer, which may help to improve pole slip prevention.

If the threshold angle θₜₕ is exceeded by the actual load angle θₑ, method 400 proceeds to step 408. At step 408, a control signal for reducing a magnitude of the current supplied to the windings is generated. The control signal may be sent to a drive unit 302.

If the threshold angle is not exceeded, the method 400 may return to step 402 in order to continue monitoring of the load angle on system 200.

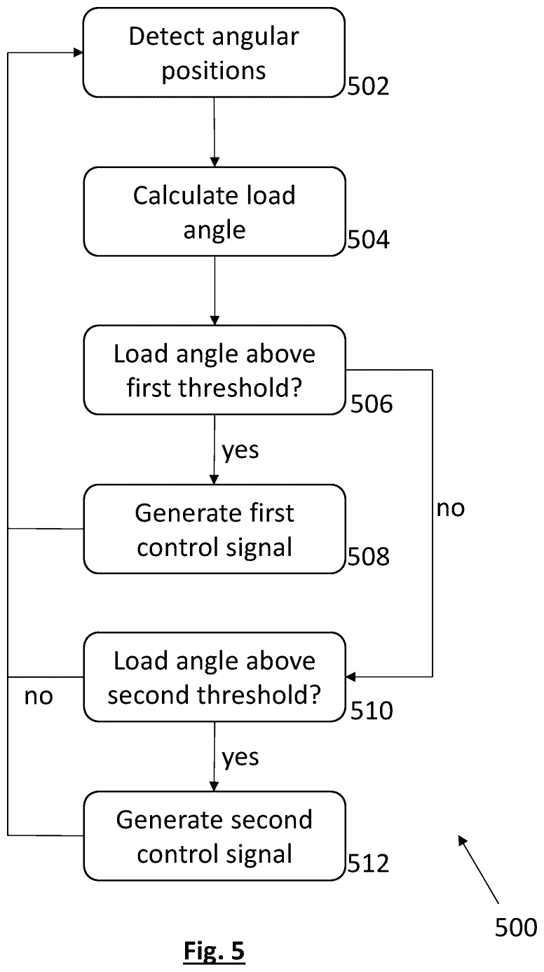

FIG. 5 shows a second method 500 of controlling the current supplied to the windings 108 in the system 200 of FIG. 2, according to the present disclosure. According to the second method, multiple thresholds are used, and the amount by which the current is adjusted (reduced) depends on which of the thresholds is exceeded. If a first (lower) threshold is exceeded, a first (small) correction amount is applied. If a second (higher) threshold is exceeded, a second (large) correction amount is applied.

At step 502, an angular position of the first rotor 104 is determined based on a signal from the first rotary encoder 202; and an angular position of the second rotor 106 is determined based on a signal from the second rotary encoder 204.

At step 504, a load angle (θₑ) of the system is calculated, using equation 6 above.

At step 506, the calculated load angle de (actual load angle) is compared with a first threshold load angle (θₜₕ₁).

If the first threshold load angle θₜₕ₁ is exceeded, method 500 proceeds to step 508. At step 508, a first correction signal for reducing the current supplied to the windings 108 is generated.

If the first threshold load angle θₜₕ₁ is not exceeded, method 500 proceeds to step 510. At step 510, the calculated load angle θₑ (actual load angle) is compared with a second threshold load angle (θₜₕ₂).

If the second threshold load angle θₜₕ₂ is exceeded, method 500 proceeds to step 512. At step 512, a second correction signal for reducing the current supplied to the windings 108 is generated.

If the second threshold load angle θₜₕ₂ is not exceeded, method 500 returns to step 502 to continue monitoring of the load angle on the system 200.

The first threshold angle may be lower than the second threshold angle. For example, the first threshold angle may be 70°, and the second threshold angle may be 80°. The first correction signal may instruct a greater reduction in the magnitude of the current than the second correction signal. For example, the first correction signal may instruct a 20% reduction in the magnitude of the current, and the second correction signal may instruct a 10% reduction in the magnitude of the current.

In some examples, the size of the correction may be proportional to the amount by which a threshold is exceeded. For example, the size of the correction may be governed by the following equation 9 for load angles (θₑ) between a first threshold (θₜₕ₁) and, a second threshold (θₜₕ₂) which is higher than the first threshold:

$$Correction ( \% ) = {C}_{max} \cdot ( \frac{{θ}_{th 2} - {θ}_{e}}{{θ}_{th 2} - {θ}_{th 1}} ) , \qquad ( 9 )$$

where Cₘₐₓ is a predetermined maximum percentage correction, such as 20%, θₜₕ₂ may for example be 80°. θₜₕ₁ may for example be 70°. As the reader will understand, Cₘₐₓ, θₜₕ₂, and θₜₕ₁ may be selected as required.

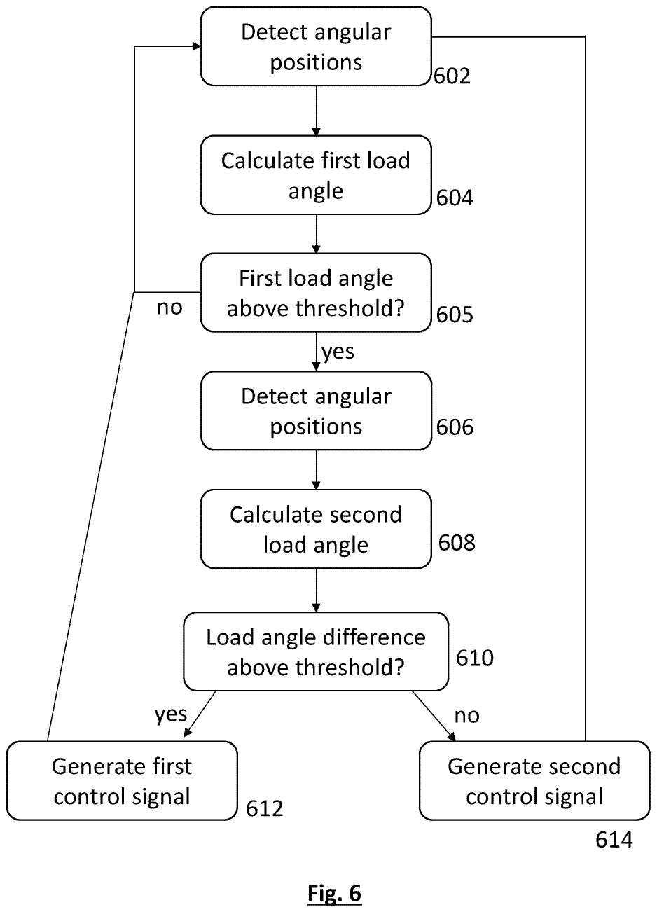

FIG. 6 shows a third method 600 of controlling the current supplied to the windings 108 in the system 200 of FIG. 2, according to the present disclosure. According to the third method, the current supplied to the windings is adjusted (reduced) by an amount which is dependent upon (for example, proportional to) the rate at which the load angle is increasing above a threshold.

At step 602, a first angular position of the first rotor 104 is determined based on a signal from the first rotary encoder 202; and a first angular position of the second rotor 106 is determined based on a signal from the second rotary encoder 204.

At step 604, a first load angle θₑ₁ of the system is calculated, using equation 6 above.

At step 605, the first load angle θₑ₁ is compared with a threshold load angle θₜₕ.

If the first load angle θₑ₁ is lower than the threshold load angle θₜₕ, the method 600 returns to step 602.

If the first load angle θₑ₁ is higher than the threshold load angle θₜₕ, the method 600 proceeds to step 606. At step 606, a predetermined period of time after step 604, a second angular position of the first rotor 104 is determined based on a signal from the first rotary encoder 202; and a second angular position of the second rotor 106 is determined based on a signal from the second rotary encoder 204.

At step 608, a second load angle θₑ₂ of the system is calculated, using equation 6 above, the second load angle being indicative of the load angle after the predetermined period of time after step 604.

At step 610, a difference between the second load angle θₑ₂ and the first load angle θₑ₁ is calculated, and the difference is compared with a threshold difference θ_{d}.

If the difference exceeds the threshold difference θ_{d}, the method 600 proceeds to step 612. At step 612, a first control signal for reducing a magnitude of the current supplied to the windings is generated. The first control signal may be sent to a drive unit 302.

If the difference does not exceed the threshold difference θ_{d}, the method proceeds to step 614. At step 614, a second control signal for reducing the magnitude of the current supplied to the windings is generated. The second control signal may be sent to a drive unit 302.

The first control signal may be an instruction to reduce the magnitude of the current supplied to the windings by a first amount which is larger than the second amount. For example, the first control signal may instruct a 20% reduction in current magnitude, while the second control signal may instruct a 10% reduction in current magnitude. As the reader will understand, these are just examples and other values may be used.

In some examples, the size of the correction may be proportional to the rate at which the load angle is increasing above the first load angle θₑ₁.

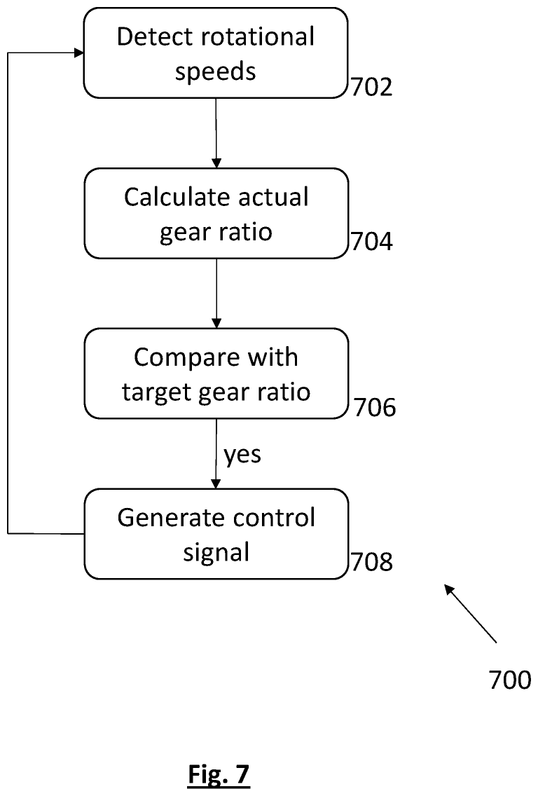

FIG. 7 shows a fourth method 700 of controlling the current supplied to the windings 108 in the system 200 of FIG. 2, according to the present disclosure. According to the fourth method, an actual gear ratio is calculated based on the rotational speeds of the two rotors, and a correction is applied when the actual gear ratio differs from a target gear ratio by a predetermined amount.

At step 702, a rotational speed of the first rotor 104 is determined based on a signal from the first rotary encoder 202; and a rotational speed of the second rotor 106 is determined based on a signal from the second rotary encoder 204.

At step 704, an actual gear ratio of the system 200 is calculated according to equation 10 below.

$$actual gear ratio = \frac{rotational speed of first rotor 104}{rotational speed of second rotor 106} \qquad ( 10 )$$

At step 706, the actual gear ratio of the system 200 is compared with a target gear ratio of the system. The target gear ratio is given by equation 11, and is predefined as the reader will understand.

$$target gear ratio = \frac{number of second permanent magnets 110}{number of pole pieces 112} \qquad ( 11 )$$

At step 708, a control signal is generated based on a difference between the actual gear ratio and the target gear ratio. For example, the greater the difference, the greater the correction (i.e. the greater the reduction in the magnitude of the current). In some examples, a correction (e.g. reduction) may be applied when the difference exceeds a predetermined threshold. As with the second method of FIG. 5, multiple thresholds may be used. That is to say, a first (lower) correction may be applied if a first (lower) threshold is exceeded; and a second (higher) correction may be applied if a second (higher) threshold is exceeded. In some examples, adjustment of the current by the controller may only be started when the difference exceeds a minimum threshold.

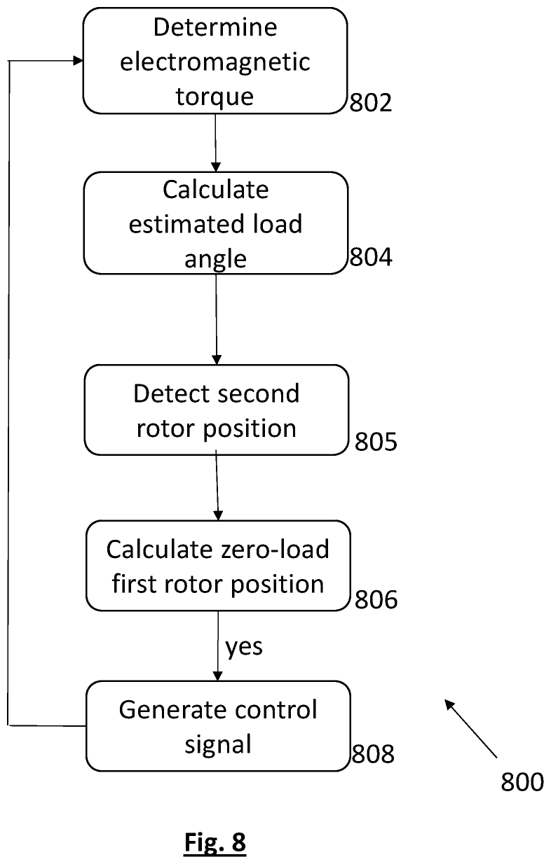

FIG. 8 shows a fifth method of controlling the current supplied to the windings 108 in the system 200 similar to FIG. 2. However, the fifth method does not require any position sensor on the first rotor 104, as will become clear below.

Assuming no transient load torque Text on the system (i.e. a case in which Text=0), we can rearrange equations 7 and 8 to get the following theoretical load angle θₑ for the system:

$${θ}_{e} = arcsin \frac{{T}_{int}}{{T}_{max}} \qquad ( 11 )$$

Therefore, the theoretical load angle, ignoring any transient load torque Text on the system, can be calculated based on the applied electromagnetic torque Tᵢₙₜ (which is proportional to the magnitude of the current supplied to the windings 118) and the maximum torque of the system (which itself is a known parameter of the system).

When a transient load torque Text is applied to the system, the above estimate for the load angle will not be a true reflection of the actual load angle on the system. There will be a phase error between the two. As a result, by supplying a current to the windings based on the estimated load angle, an additional phase shift will be introduced to the system. A small phase error will result in only a small reduction in the effective electromagnetic torque on the system. However, a large phase error—i.e. a phase error arising when the real load angle of the system approaches 90° (i.e. approaches a pole slip condition)—will result in a significant reduction in the effective electromagnetic torque, and therefore a significant reduction in the total applied torque. This is illustrated in equation 13 below:

$$Effective Electromagnetic Torque = {T}_{max} \cdot ( 1 - cos ( {θ}_{act} - {θ}_{est} ) ) \qquad ( 13 )$$

In short, the phase error between the estimated and actual load angle can be advantageously used to reduce torque on the system as the actual load angle approaches pole slip condition.

In particular, by continuing to drive the system according to the estimated load angle, where the estimated load angle is calculated based (only) on the electromagnetic torque and the known maximum torque of the system, the system can self-regulate for transient applied torques, whereby the total applied torque is reduced in the case of a high transient torque, thereby preventing pole slip from occurring.

Accordingly, according to the fifth method 800, in step 802 the controller determines the electromagnetic torque (Tᵢₙₜ) applied to the system, based on a magnitude of the current (I) supplied to the windings, according to equation 14:

$${T}_{int} = k \cdot I , \qquad ( 14 )$$

where k is a known, system-specific torque constant, and I is the magnitude of the current supplied to the windings. In some examples, the relationship between Tᵢₙₜ and I may be known by a lookup table.

At step 804, the controller calculates the estimated load angle according to equation 12, where Tmax is a known property of the system.

At step 805, a rotational position of the second rotor (θ_{R2}) is detected.

At step 806, the controller calculates a theoretical zero load first rotor position (θ₁) according to equation 15:

$${θ}_{1} = {θ}_{R 2} \cdot gear ratio \qquad ( 15 )$$

where the gear ratio is a known property of the system as has been described above.

At step 808, the controller controls a phase of the current supplied to the windings such that the rotating magnetic field is offset from the magnetic field associated with the theoretical first rotor position by the estimated load angle, for example according to equation 16:

$${θ}_{windings} = {N}_{1} {θ}_{1} + {θ}_{e} , \qquad ( 16 )$$

where N₁θ₁ is an electrical angle associated with the theoretical first rotor position.

Through this approach, the method 800 self-regulates for torque transients to thereby prevent pole slip.

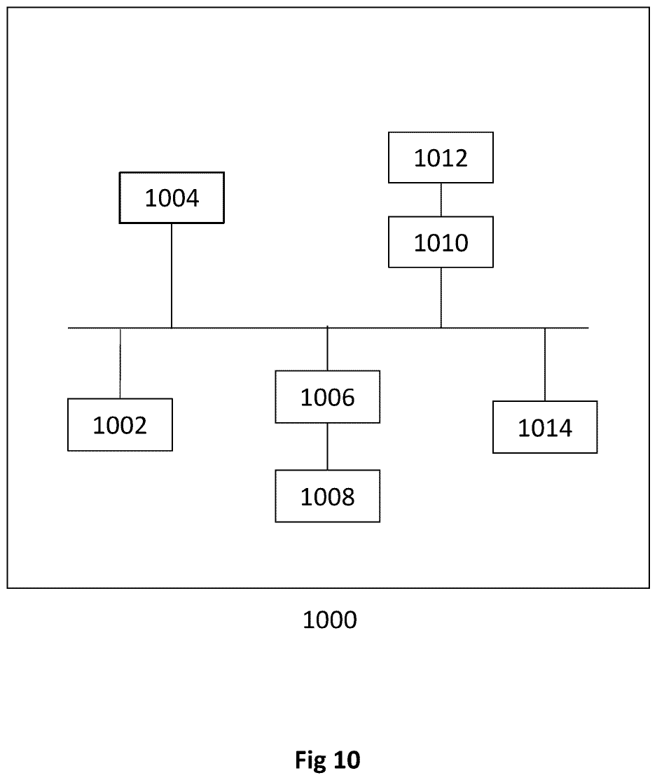

Turning finally to FIG. 10, FIG. 10 shows a schematic and simplified representation of a computer apparatus 1000 which can be used to perform methods described herein, either alone, in combination with other computer apparatuses or as part of a network or a “cloud” computing arrangement.

The computer apparatus 1000 comprises various data processing resources such as a processor 1002 (in particular, a hardware processor) coupled to a central bus structure. Also connected to the bus structure are further data processing resources such as memory 1004. A display adapter 1006 connects a display device 1008 to the bus structure. One or more user-input device adapters 1010 connect a user-input device 1012, such as a keyboard and/or a mouse to the bus structure. One or more communications adapters 1014 are also connected to the bus structure to provide connections to other computer systems 1000 and other networks.

In operation, the processor 1002 of computer system 1000 executes a computer program comprising computer-executable instructions that may be stored in memory 1004. When executed, the computer-executable instructions may cause the computer system 1000 to perform one or more of the methods described herein. The results of the processing performed may be displayed to a user via the display adapter 1006 and display device 1008. User inputs for controlling the operation of the computer system 1000 may be received via the user-input device adapters 1010 from the user-input devices 1012.

It will be apparent that some features of computer system 1000 shown in FIG. 10 may be absent in certain cases. For example, one or more of the plurality of computer apparatuses 1000 may have no need for display adapter 1006 or display device 1008. This may be the case, for example, for particular server-side computer apparatuses 600 which are used only for their processing capabilities and do not need to display information to users. Similarly, user input device adapter 1010 and user input device 1012 may not be required. In its simplest form, computer apparatus 1000 comprises processor 1002 and memory 1004.

The described arrangements and methods are merely exemplary, and it will be appreciated by a person skilled in the art that various modifications can be made without departing from the scope of the appended claims.

More generally, it should be appreciated that the number of steps shown in the figures is not intended to be limiting. Steps may be repeated as often as necessary and certain steps may be omitted.

The computer apparatus discussed above may be a local computer or a server.

While various specific combinations of components and method steps have been described, these are merely examples. Components and method steps may be combined in any suitable arrangement or combination. Components and method steps may also be omitted to leave any suitable combination of components or method steps.

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

In an implementation, the modules, components and other features described herein can be implemented as discrete components or integrated in the functionality of hardware components such as ASICS, FPGAs, DSPs or similar devices.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

Also disclosed herein are a number of broad concepts according to the following numbered clauses. As the reader will understand, any number of the following clauses may be combined. As the reader will also understand, the following numbered clauses may apply to the system 200 as described above and as shown in FIG.
1. A system that detects external torque disturbances by monitoring the load angle between the rotors.
2. A system that monitors load angle and uses a threshold or maximum value beyond which a corrective torque is applied to prevent pole slip.
3. A system that uses increased correction as the load angle deviates further past the threshold.
4. A system that uses the relative rotor speeds to monitor the gear ratio in real time and pass the value to the controller for diagnostic purposes.
5. A system that compares the gear ratio to a known expected value and, if the value exceeds a threshold, applies a correction.
6. A system that uses an estimation of load angle that does not provide correction for externally applied torque, hence reducing applied rotor torque automatically.
7. A system that induces a phase error between the rotor position and current waveform to reduce torque output of the machine to provide pole slip prevention.
8. A system that uses a signal proportional to the speed error between the rotors to provide an input signal to the controller to apply pole slip preventative torque.
9. A system that calculates an expected load angle from the applied torque and compares with the measured load angle to provide diagnostic data to the drive.
10. A system that places a threshold of allowable load angle around the expected value, outside of which the controller provides corrective torque to prevent pole slip.
11. A system that detects pole slip by using the relative speed of the rotors.
12. A system that detects pole slip by using the measured load angle between the rotors.
13. A system that once pole slip is detected will provide a torque demand to the HSR that seeks to change its speed to be equal to the speed that will allow rotor resynchronisation.

The examples described and shown in the accompanying drawings are provided as examples of ways in which the invention may be put into effect and are not intended to be limiting on the scope of the invention. Modifications may be made, and elements may be replaced with functionally and structurally equivalent parts, and features of different embodiments may be combined without departing from the disclosure. In particular, the features described in the above examples may be combined with one another insofar as such a combination is technically possible.

1. A system comprising:
a stator comprising a plurality of windings configured to generate a rotating magnetic field;
a first rotor comprising a plurality of permanent magnets having an associated second magnetic field;
a second rotor through which the rotating magnetic field and the second magnetic field are coupled, whereby rotation of the first rotor is magnetically coupled to rotation of the second rotor;
a first rotational sensor associated with the first rotor;
a second rotational sensor associated with the second rotor; and
a controller configured to control a current supplied to the windings based on a signal from the first sensor and a signal from the second sensor;
wherein one of the first rotor and the second rotor is a drive rotor configured for attachment to an external load, and the other of the first rotor and the second rotor is a passive rotor.

2. The system of claim 1, wherein the second rotor is the drive rotor.

3. The system of claim 1, wherein the stator further comprises a plurality of permanent magnets having an associated first magnetic field.

4. The system of claim 3, wherein the second rotor is arranged to couple the magnetic fields of the stator with the second magnetic field.

5. The system of claim 1, wherein the second rotor comprises a plurality of pole pieces through which the magnetic field(s) of the stator couple with the second magnetic field.

6. The system of claim 1, wherein each rotational sensor comprises a rotary encoder or a rotary resolver.

7. The system of claim 1, wherein each sensor outputs a signal indicative of an angular position of the respective rotor, and wherein the controller is configured to:
determine a load angle of the system based on the angular position of the first rotor and the angular position of the second rotor; and
adjust the current supplied to the windings based on the determined load angle.

8. The system of claim 7, wherein the controller is configured to modify a magnitude of the current supplied to the windings when the load angle increases above a predetermined threshold.

9. The system of claim 8, wherein the controller is configured to modify the magnitude of the current supplied to the windings in proportion to an amount by which the load angle exceeds the predetermined threshold.

10. The system of claim 8, wherein the controller is configured to modify the magnitude of the current supplied to the windings in proportion to a rate at which the load angle increases above the predetermined threshold.

11. The system according to claim 1, wherein each sensor outputs a signal indicative of a rotational speed of the respective rotor, and wherein the controller is configured to:
determine a gear ratio between the first and second rotors based on the rotational speeds of the rotors; and
adjust the current supplied to the windings based on the determined gear ratio.

12. The system according to claim 11, wherein the controller is configured to:
determine an actual gear ratio between the first and second rotors based on the rotational speeds of the rotors;
detect when the actual gear ratio differs from a target gear ratio by a predetermined amount; and
reduce a magnitude of the current supplied to the windings when the actual gear ratio differs from the target gear ratio by the predetermined amount.

13. A method of operating a system, the system comprising:
a stator comprising a plurality of windings configured to generate a rotating magnetic field;
a first rotor comprising a plurality of permanent magnets having an associated second magnetic field; and
a second rotor through which the rotating magnetic field and the second magnetic field are coupled, whereby rotation of the first rotor is magnetically coupled to rotation of the second rotor;
wherein one of the first rotor and the second rotor is a drive rotor configured for attachment to an external load, and the other of the first rotor and the second rotor is a passive rotor,
the method comprising:
determining one of a angular position and a rotational speed of the first rotor;
determining one of a angular position and a rotational speed of the second rotor; and
controlling a current supplied to the windings based on the determined angular position or rotational speed of the first rotor, and based on the determined angular position or rotational speed of the second rotor.

14. The method of claim 13, wherein the angular position of the first rotor and the angular position of the second rotor are determined, the method further comprising:
determining a load angle of the system based on the angular position of the first rotor and the angular position of the second rotor; and
adjusting the current supplied to the windings based on the determined load angle.

15. The method of claim 14, wherein the magnitude of the current supplied to the windings is reduced when the load angle increases above a predetermined threshold.

16. The method of claim 15, wherein the magnitude of the current supplied to the windings is reduced in proportion to an amount by which the load angle exceeds the predetermined threshold or wherein the magnitude of the current supplied to the windings is reduced in proportion to a rate at which the load angle increases above the predetermined threshold.

17. (canceled)

18. The method of claim 13, wherein the rotational speed of the first rotor and the rotational speed of the second rotor are determined, the method further comprising:
determining a gear ratio between the first rotor and the second rotor based on the rotational speeds of the rotors; and
modifying a magnitude of the current supplied to the windings based on the determined gear ration.

19. The method of claim 18, comprising:
determining an actual gear ratio between the first and second rotors based on the rotational speeds of the rotors;
detecting when the actual gear ratio differs from a target gear ratio by a predetermined amount; and
deducing the magnitude of the current supplied to the windings when the actual gear ratio differs from the target gear ratio by the predetermined amount.

20. A system comprising:
a stator comprising a plurality of windings configured to generate a rotating magnetic field;
a first rotor comprising a plurality of permanent magnets having an associated second magnetic field;
a second rotor through which the rotating magnetic field and the second magnetic field are coupled, whereby rotation of the first rotor is magnetically coupled to rotation of the second rotor;
a rotational sensor associated with the second rotor and configured to detect a rotational position of the second rotor; and
a controller configured to:
calculate an electromagnetic torque in the system, based on a magnitude of a current supplied to the windings;
calculate an estimated load angle of the system based on the electromagnetic torque and a known maximum torque capacity of the system;
calculate a theoretical first rotor position based on the detected second rotor position and a known gear ratio of the system; and
control a phase of the current supplied to the windings such that the rotating magnetic field is offset from an electrical angle associated with the theoretical first rotor position by the estimated load angle.

21. A method of operating a system,
the system comprising:
a stator comprising a plurality of windings configured to generate a rotating magnetic field;
a first rotor comprising a plurality of permanent magnets having an associated second magnetic field;
a second rotor through which the rotating magnetic field and the second magnetic field are coupled, whereby rotation of the first rotor is magnetically coupled to rotation of the second rotor; and
a rotational sensor associated with the second rotor and configured to detect a rotational position of the second rotor;
and the method comprising:
calculating an electromagnetic torque in the system, based on a magnitude of a current supplied to the windings;
calculating an estimated load angle of the system based on the electromagnetic torque and a known maximum torque capacity of the system;
calculating a theoretical first rotor position based on the detected second rotor position and a known gear ratio of the system; and
controlling a phase of the current supplied to the windings such that the rotating magnetic field is offset from an electrical angle associated with the theoretical first rotor position by the estimated load angle.
